(19) United States
(12) Patent Application Publication
(10) Pub. No.: US 2016/0162550 A1
(43) Pub. Date: Jun. 9, 2016

(54) METHOD, APPARATUS, AND APPLICATION SYSTEM FOR REAL-TIME PROCESSING THE DATA STREAMS

(71) Applicant: ETU CORPORATION, TAIPEI CITY (TW)

(72) Inventors: YAO-TSUNG WANG, TAIPEI CITY (TW); YU-LIN YEH, TAIPEI CITY (TW); JUI-HSING HSU, TAIPEI CITY (TW); WEI-JHIH CHEN, TAIPEI CITY (TW)

(21) Appl. No.: 14/956,411

(22) Filed: Dec. 2, 2015

(30) Foreign Application Priority Data
Dec. 5, 2014 (TW) 103142344

(51) Int. Cl. G06F 17/30

(52) U.S. Cl. CPC G06F 17/30516; G06F 17/30569; G06F 17/30578; G06F 17/30581; G06F 17/30563

(57) ABSTRACT

Disclosed are a method, a data processing engine, and a system for real-time processing a plurality of continuously-generated data streams. The method for real-time processing the data with different schemas that transmit from heterogeneous relational databases includes steps of identifying categories the data, converting the data, and then storing the data in a non-relational data. Moreover, an architecture is provided together with the system and the method to improve the management of products, product lines or lifecycle such as the feedback of information regarding the performance analysis of an online game, or real-time alerts and recommended actions regarding the yield rate in a manufacturing stage of an industry such as the semiconductor manufacturing industry.

### CROSS-REFERENCE TO RELATED APPLICATIONS

This non-provisional application claims priority under 35 U.S.C. §119(a) on Patent Application No(s) 103142344 filed in Taiwan, R.O.C. on Dec. 5, 2014, the entire contents of which are hereby incorporated by reference.

### FIELD OF THE INVENTION

The technical fields of the invention relate to real-time processing of big data and data warehouse, and more particularly to a method, an engine and a system for real-time processing continuously-generated data streams with the effects of instant query and alert.

### BACKGROUND

Companies have encountered difficulty when attempting to incorporate data analysis into their decision-making processes. For example, in a company, information systems of a department's choice are usually selected or designed to fulfill its own operation or departmental objective. Given the circumstances, information systems of different departments are separated from each other, which leads to data silos spread across the organization from a central perspective of the company. This causes troublesome situations—despite large amount of data collected and stored, useful and valuable information/insight that can be extracted therefrom is still limited. To consolidate and integrate the siloed data, companies used to use a data warehouse system with storage capacity and analysis capability to build an integrated data hub. With the data warehouse system, companies are offered flexibility and agility to analyze, utilize and explore the data and able to create data-driven operations within the organization.

FIG. 1 is a schematic block diagram of a conventional application of data warehouse in industries. Data streams derived from a plurality of data sources 10 are consolidated and stored in a relational database 11, pre-processed by an ETL (extract, transform, load) tool 12 on a batch-by-batch basis, and imported to a data warehouse 13. The data streams in the data warehouse 13 can be further processed by a batch analysis and processing tool 14 when necessary and an output derived therefrom can be provided for a query (not shown) or presented in a statistical report 15.

In the semiconductor manufacturing field, the aforementioned application of the data warehouse is applicable to processes such as etching and lithography. In the digital entertainment industry, it can be applied to the lifecycle management of online games. The application of the data warehouse in the semiconductor manufacturing field is described in detail. The data sources 10 can be machines or engine commonly used or seen in semiconductor manufacturing processes. Data streams (not shown) continuously generated by the data sources 10 are transmitted to the relational database 11. The relational database 11 herein stores the data streams such as logs generated during the processes. According to practical experience, the storage capacity of the relational database 11 can accommodate the data streams that are continuously generated during 14 days. This incurs a problem as in most cases the duration of a manufacturing process takes more than 14 days. A conventional approach for the industry to cope with the problem is to store the data streams pre-processed by the ETL tool 12 in the data warehouse 13 with a larger capacity, e.g. a capacity that can support to receive data streams continuously generated during a time frame of two years. The data streams in the data warehouse 13 can be further processed by the batch analysis and processing tool 14 in order for a specific purpose such as yield analysis. The output derived therefrom can be provided for a third-party application (not shown) to perform an instant query and/or presented in the statistic report 15, in charts, in tables, on dashboard or on websites. In most cases, the batch analysis and processing tool 14 carries out the further processing of the data streams once a month and each time it takes several hours.

However, there exist some drawbacks to the conventional approach. For the semiconductor manufacturing industry, the workflow between the data sources 10 and the relational database 11 is mission-critical and the design thereof will not be altered unless necessary. Given the circumstances, the size of the relational database 11 is too small to accommodate a large amount of the data streams generated during the whole manufacturing process. What makes it even worse is that the relational database 11 cannot be horizontally scaled, i.e. scaled out. Another drawback is that the data streams transmitted from the relational database 11 is pre-processed by the ETL tool 12 on a batch-by-batch basis, which is time-consuming and thus cannot be provided for real-time alerts. In addition, the data warehouse has to be scaled when the volume of the data streams grows, which incurs costly expenditures on both software license and hardware upgrade. The above drawbacks hinder the efforts that the semiconductor manufacturing industry makes to real-time monitor and control the fabrication processes at a reasonable and affordable cost.

Similar situations and problems are seen in the online gaming field. Referring to FIG. 1, the data sources 10 can be devices of gamers' such as their mobile phones, computers or video game consoles. Data streams of gamers' online behaviors such as logins and subscriptions are stored in the relational database 11, pre-processed by the ETL tool 12 on a batch-by-batch basis that usually takes hours, and then stored in the data warehouse 13. Based on a predetermined frequency, e.g. monthly, online gaming operators can use the batch analysis and processing tool 14 to further process the data streams transmitted from the data warehouse 13. The output (not shown) thereof can be provided for queries or presented in the statistical report 15 assisting the online gaming operators in managing the lifecycle of online games. Due to shrinking lifespans of online games, a method and system provided for real-time analysis of performance of online games at a reasonable cost are needed for the digital entertainment industry to optimize product portfolios and proactively formulate precision marketing strategies.

In view of the above, inventors of the present invention disclose a method and system that can overcome the drawbacks of the prior art based on their working experiences in industries.

### SUMMARY

Therefore, it is a primary objective of this disclosure to provide a method for real-time processing the data streams and its system architecture, and a system architecture for executing the method, and the method and system architecture are used for instantly managing the large volume streaming data coming from different relational databases.

To achieve the aforementioned and other objectives, this disclosure provides a method for real-time processing the data streams and receiving a plurality of data streams from at least one relational database via network connection to process the data streams, and then outputting and storing at least one non-relational database. The method comprises the steps of: identifying the data type of the relational databases according to a plurality of ports of a network connection; setting a communication mode of the data streams transmitted from the relational database to a synchronous mode or an asynchronous mode; sequentially retrieving each record of incremented data streams according to a primary index; determining whether the data type of the relational database used as a source supply and the data type of the non-relational database used as a target receipt are the same, if yes, then it is not necessary to convert the data streams, or else the data streams are converted into the data type of the non-relational database; and writing the converted data streams or the data streams not necessary to be converted into the non-relational database according to the communication mode.

In a preferred embodiment, the data streams converted according to the communication mode or requiring no conversion are written into the non-relational database to improve the network response and reduce the coupling between software components of the system to facilitate independent development and expanding the structure. If the communication mode is asynchronous, then the converted data streams or the data streams requiring no conversion is buffered into a memory and written all into the on-relational database at a time when the data streams are continuously stored in the memory to a default data status.

To achieve the aforementioned and other objectives, this disclosure also provides a data processing engine capable of executing the foregoing instant processing method, and the data processing engine comprises: a port identification module, for identifying the data type of the relational database according to a plurality of ports of a network connection; a communication mode setting module, telecommunicatively coupled to the port identification module, for setting a communication mode of the relational database to transmit the data streams in a synchronous mode or an asynchronous mode according to the data type of the relational database; a receiving module, telecommunicatively coupled to the communication mode setting module, for sequentially retrieving each incremental data record; a conversion module, telecommunicatively coupled to the receiving module, for determining whether or not the data type of the relational database acting as a supply source is the same as the data type of the non-relational database acting as a receiving target; if yes, then no conversion of the data streams will be required, or else the data streams will be changed to the data type of the non-relational database; and an export module, telecommunicatively coupled to the receiving module, for writing the converted data streams or the data streams requiring no conversion into the non-relational database according to the communication mode; wherein if the communication mode is asynchronous, then the converted data streams of the data streams requiring no conversion will be buffered in a memory, until the data streams successively stored in the memory reach a default data status, and the data streams are all written in the non-relational database at a time.

Based on the aforementioned instant processing method and data streams processing engine, this disclosure further provides a system for real-time processing the data streams, and the system comprises: a first database, being of a structured database type and providing a plurality of data streams; a second database, being of a structured database type; a replicator, telecommunicatively coupled to the a first database and the a second database, and having a replication function for synchronously updating the data in the a first database to the a second database; an ETL tool, telecommunicatively coupled to the a first database; a data warehouse, being of a structured database type and telecommunicatively coupled to the ETL tool, wherein the data streams supplied by the a first database are pre-processed by the ETL tool and then transmitted to the data warehouse for storage; the aforementioned data processing engine telecommunicatively coupled to the a second database, wherein the data streams supplied by the a second database are transmitted to the data streams processing engine; and a distributed database, being of a unstructured database type, and telecommunicatively coupled to the data streams processing engine, for writing in the data streams processed by the data streams processing engine.

In another preferred embodiment, the aforementioned system for real-time processing the data streams further comprises an real-time alert unit telecommunicatively coupled to the distributed database for instantly providing a change status of the data stored in the distributed database to let managers confirm the reports for confirming the level of target achievement, the level of performance management, and business analysis. In some areas such as the semiconductor manufacturing industry, the data streams of the data warehouse are processed by a batch analysis and processing tool to obtain an alert level value, and then the real-time alert unit compare with the change status to generate an instant alert notification according to the alert level value to facilitate managers to conduct instant processing, so as to achieve the effect of knowing the yield rate of a wafer manufacturing process instantly.

The method, engine and system for real-time processing the data streams in accordance with this disclosure are capable to provide the instant query, warning and other management effects in a speed to a few seconds. Since the environment is in a distributed instant processing structure, therefore the required expensive software license and hardware upgrade can be avoided to cope with the processing of the large volume data, so as to reduce the construction cost significantly.

### BRIEF DESCRIPTION OF THE DRAWINGS

FIG. 1 is a schematic view of a conventional data warehouse,

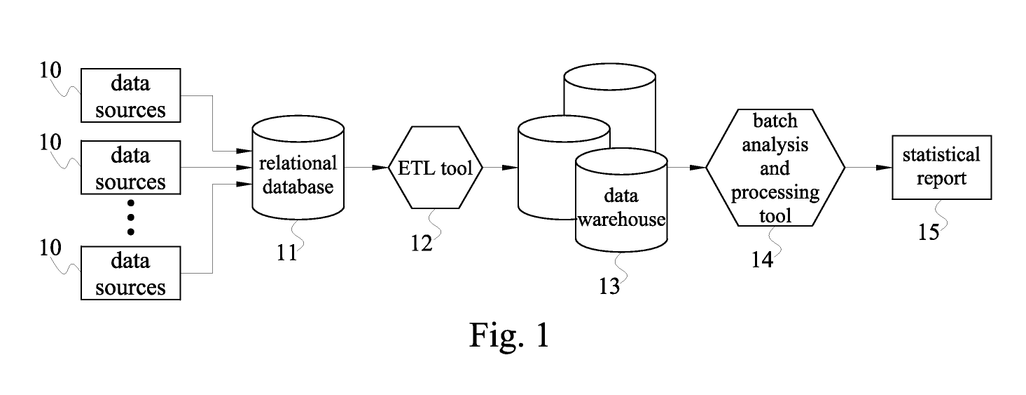

FIG. 2 is a schematic block diagram of a data streams processing structure in accordance with a preferred embodiment of this disclosure;

FIG. 3 is a schematic block diagram of a data processing engine in accordance with a preferred embodiment of this disclosure;

FIG. 4 shows a flowchart of a method for real-time processing the data streams in accordance with a preferred embodiment of this disclosure;

FIGS. 5A and 5B show a flowchart of a method for real-time processing the data streams in accordance with a preferred embodiment of this disclosure; and

FIG. 6 is a schematic block diagram of a system for real-time processing the data streams in accordance with a preferred embodiment of this disclosure.

### DESCRIPTION OF THE PREFERRED EMBODIMENTS

The disclosure hereby elaborates on the present invention with figures. To help Examiners comprehend the invention, any label consistently appearing in different figures refers to the same element, block, component, step, procedure, process or concept.

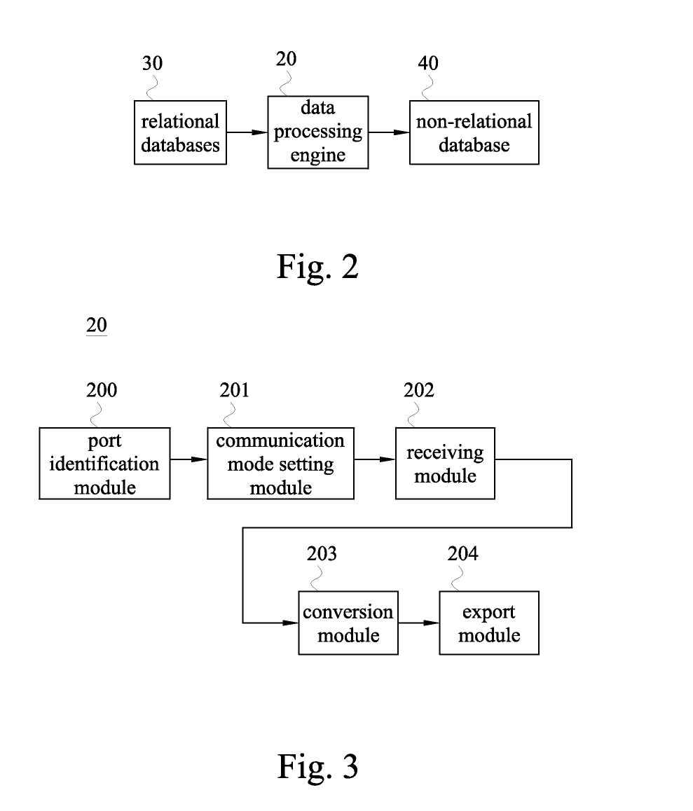

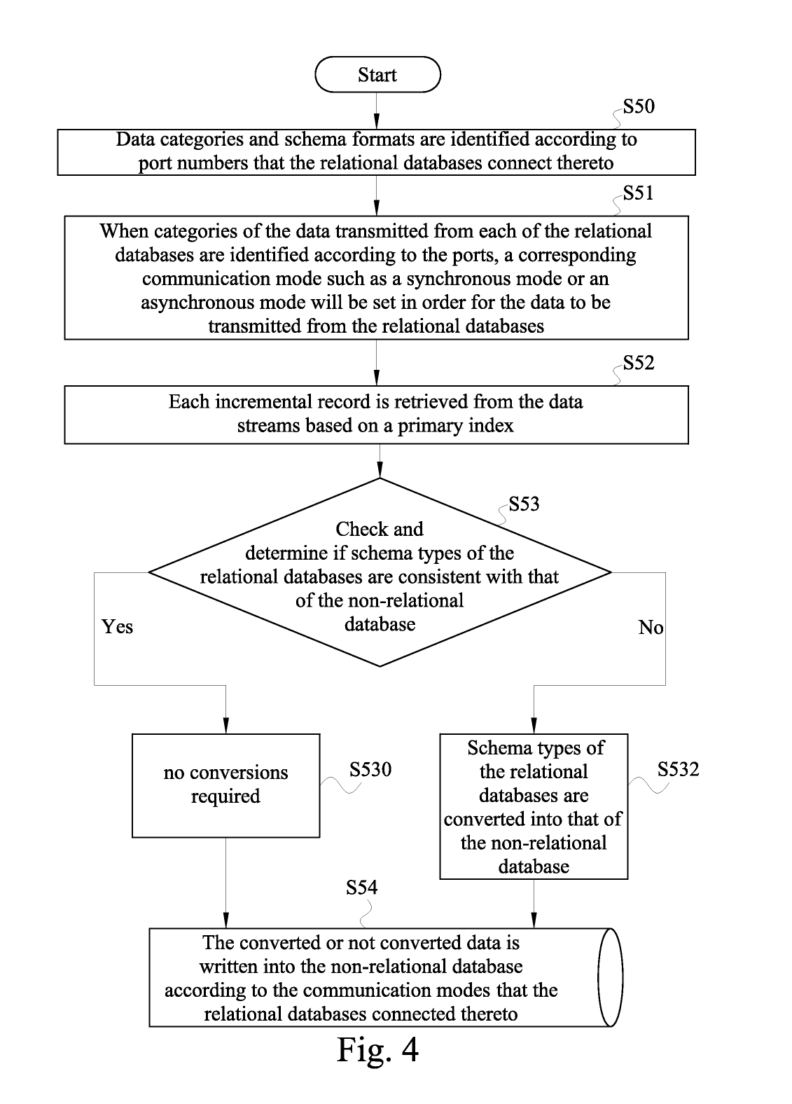

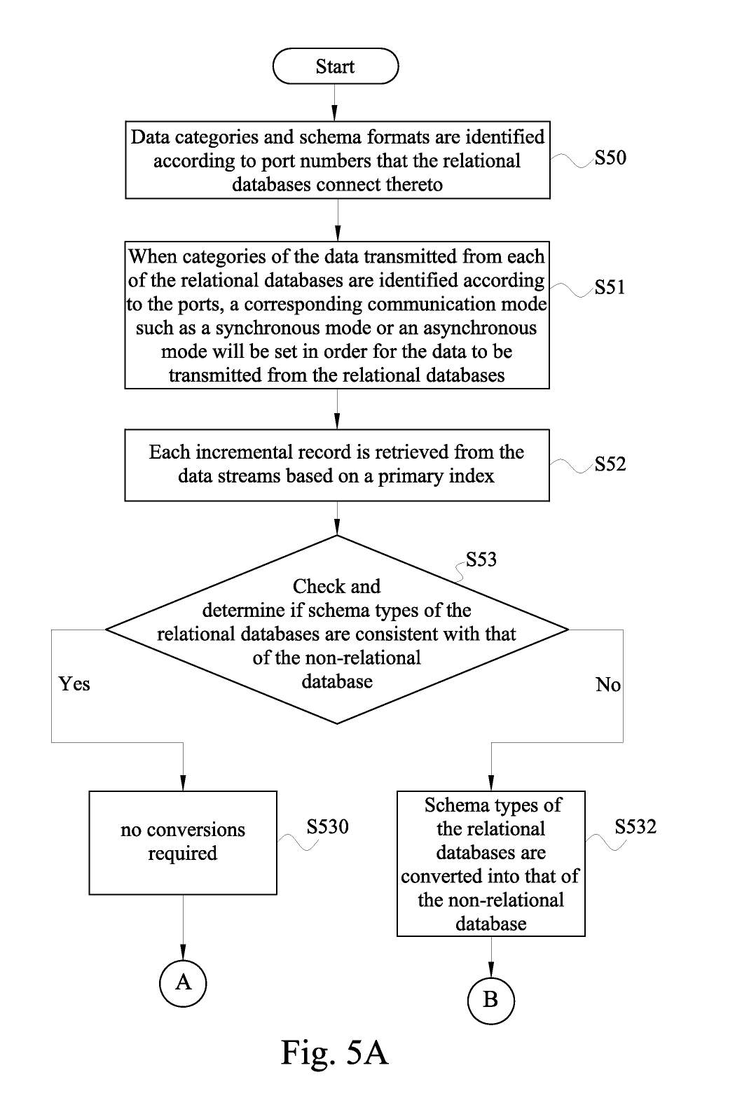

FIGS. 2 to 4 disclose a preferred embodiment of the invention, in which FIG. 2 shows an architecture of a system that can process continuously-generated data streams in real time, FIG. 3 describes the data processing engine 20 of the system in detail, and FIG. 4 is a flowchart that shows a method for real-time processing of the continuously-generated data streams with the data processing engine 20. Referring to FIG. 2, the data processing engine 20 continuously receives and real-time converts a plurality of data streams (not shown) transmitted from a plurality of relational databases 30 through a network. Outputs (not shown) derived from the conversion of the plurality of data streams are then transmitted to and stored in at least one non-relational database 40. The data streams comprising properties of high volume, high variety and high velocity are continuously generated, and arrows in FIG. 2 indicate the data flow of the data streams. In the prior art, data written to a database is stored on a hard disk, the processing of the data are triggered while a query request made by an application is received, and a query result is cached in memory. It is noticed that the query request triggers the processing of the whole of data, thus the performance of computing will begin to decline when data volume grows. In addition, reading and writing data to the hard disk are slow due to its physical limitations. As a consequence, the time between a query and a result arriving at a screen will increase. To avoid drawbacks of the prior art, the present invention provides a method and system for real-time processing of the continuously-generated data streams. Without involving any step of writing data to hard disk, the disclosed invention can provide query results within time windows from one second to up to a few seconds.

Still referring to FIGS. 2 to 4, the method for real-time processing the data streams comprises the following steps. First, categories of the data transmitted from the relational databases 30 are identified, based on which to adjust setups or settings of the data processing engine 20 and the non-relational database 40. To be more specifically, data categories and formats are identified according to port (not shown) numbers that the relational databases 30 connect thereto. In this case, attributes of the data can be quickly confirmed according to port numbers that are commonly used or preset. For example, port 21 is generally accepted as FTP and port 80 as HTTP. It is noticed that the ports herein are virtual ports instead of physical ports. This paragraph describes the step of S50 in detail.

In order to reduce the network response time, the asynchronous mode is preferably set as the default communication method between the relational databases 30 and the data processing engine 20. By asynchronous it means is that messages exchanged between operational processes are not concurrent. To be more specifically, messages of a single operational process are divided into multiple stages. In each stage, a part of the messages will be exchanged when the operational process got the shared semaphore. With the asynchronous mode, coupling between software modules can be reduced. In addition, it keeps different layers of the system architecture isolated, which is more ideal for the system development. When categories of the data transmitted from each of the relational databases 30 are identified according to the ports, a corresponding communication mode such as a synchronous mode or an asynchronous mode will be set in order for the data to be transmitted from the relational databases 30. This paragraph elucidates the step of S51.

Each incremental record is retrieved from the data streams based on a primary index [S52]. Referring to FIG. 2, the data streams from the relational databases 30 are structured data and the non-relational database 40 is characterized by storing unstructured data. Take NoSQL database as an example of the non-relational database 40. NoSQL data are stored as key-value pairs. As for data relations, one can use single key with multiple column families to store related values. With this simple data structure, users do not need to pre-define the correlation between different datasets. Besides, NoSQL is “schema-free” so that users can dynamically add extra columns. The non-relational database 40 such as NoSQL provides features comprising scalability and flexibility when it comes with big data.

The next step is to check and determine if schema types of the relational databases 30, the data sources, are consistent with that of the non-relational database 40, the data destination [S53]. If so, schema types of the data from the relational databases 30 require no conversions [S530]. If not, schema types of the data will be converted into that of the non-relational database 40 [S532]. According to the aforementioned communication method, the data streams, whether converted or not, are written into the non-relational database 40 [S54].

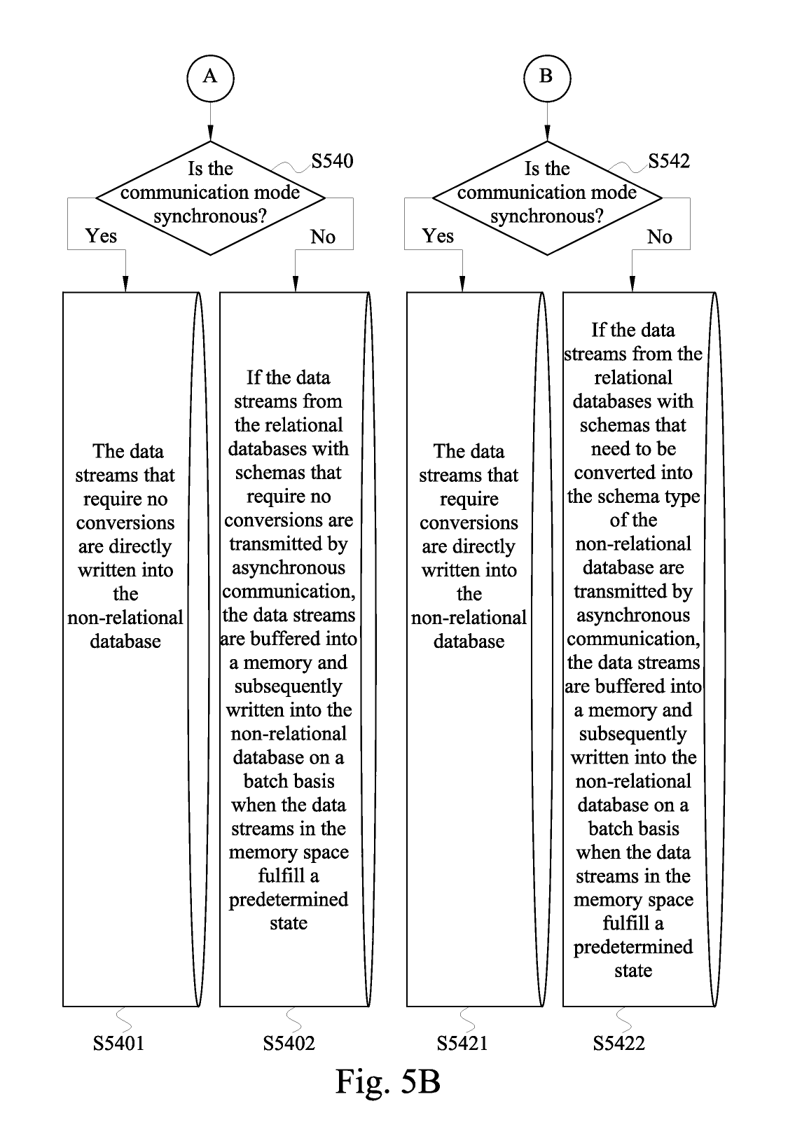

FIGS. 5A and 5B are a flowchart that elucidates the above method in more detail. It is noted that labels constantly appearing in the flowcharts represent the same steps as described FIG. 4. Hence, only step S54 will be further explained and the rest of steps will not be reiterated. As mentioned earlier, information systems are spread across the organization. The relational databases 30, in this case, refer to a plurality of heterogeneous relational databases and communication modes thereof can be either synchronous or asynchronous. When an organization is considering adopting a new technology or architecture, they normally ruminate on how to incorporate it without jeopardizing the existing security policy and IT infrastructure. With a system architecture designed to push data records from the relational databases 30, it not only meets the requirement of existing security policy but also increases scalability and response speed of the system.

Practically, asynchronous communication through message queueing techniques is chosen and used in order to improve scalability and network throughputs. While synchronous communication mode is used, data will be directly written into databases. This increases the workload and response latency of databases when data streams are processed in parallel. With the adoption of message queueing techniques, all external requests and data transmissions will get response from message queues. The process of message queue, usually deployed separately in a dedicated server farm named ‘Message Queue Servers’, will retrieve these data and write the data into database asynchronously. The message queue servers works in parallel, which makes it faster than a single database and can help reduce the response latency. Data streams are not written into hard disk; instead, they are directly processed in memory and stored as intermediate data. With the design, it is not the whole dataset but the difference between new data and intermediate data that is processed. Therefore, the processing time between an input and output can be controlled within microseconds—hundred thousand to million records can be processed per second.

The data streams from the relational databases 30, whether converted or not, are subsequently written into the non-relational database 40 based on the communication modes that the relational databases 30 connect to the data processing engine 20 [S54]. To be more specifically, the data streams from the relational databases 30 with schemas that require no conversions [S530] and the data streams from the relational databases 30 with schemas that need to be converted into the schema type of the non-relational database 40 [S532] are individually checked whether the communication modes the relational databases 30 connected thereto are synchronous [S540 and S542]. If the data streams from the relational databases 30 with schemas that require no conversions [S530] are transmitted by synchronous communication, the data streams are directly written into the non-relational database 40 [S5401]. If the data streams from the relational databases 30 with schemas that require no conversions [S530] are transmitted by asynchronous communication, the data streams are buffered into a memory and subsequently written into the non-relational database 40 on a batch basis when the data streams in the memory space fulfill a predetermined state [S5402]. Identical procedures apply to the step of S532. If the data streams from the relational databases 30 with schemas that need to be converted into the schema type of the non-relational database 40 [S532] are transmitted by synchronous communication, the data streams are directly written into the non-relational database 40 [S5421]. If the data streams from the relational databases 30 with schemas that need to be converted into the schema type of the non-relational database 40 [S532] are transmitted by asynchronous communication, the data streams are buffered into a memory and subsequently written into the non-relational database 40 on a batch basis when the data streams in the memory space fulfill a predetermined state [S5422].

FIG. 3 discloses the data processing engine 20 in detail. It is noted that FIG. 3 only addresses its modules and connections thereof. Any process, step and procedure of the data processing engine 20 are the same as FIGS. 4, 5A and 5B and thus will not be reiterated. It is also noted that the module herein refers to a combination of container, e.g. a computer or a virtual machine, and software, e.g. an application program.

Referring to FIG. 3, the data processing engine 20 comprises a port identification module 200, a communication mode setting module 201, a receiving module 202, a conversion module 203, and an export module 204. The port identification module 200 identifies categories and formats of the data from the relational databases 30 based on the ports that the relational databases 30 connect to the data processing engine 20. The communication mode setting module 201 is telecommunicatively coupled to the port identification module 200, and sets the data transmission from the relational databases to be synchronous or asynchronous. The receiving module 202 is telecommunicatively coupled to the communication mode setting module 201 and sequentially retrieves incremental data records. The data records are transmitted to the conversion module 203. The conversion module 203, telecommunicatively coupled to the receiving module 202, checks and determines if schema types of the relational databases 30, the data sources, are consistent with that of the non-relational database 40, the data destination. If so, schema types of the data from the relational databases 30 require no conversions. If not, schema types of the data will be converted into that of the non-relational database 40 by the conversion module 203. Subsequently, the data are transmitted to the non-relational database 40 through the export module 204 that is telecommunicatively coupled to the receiving module 202. To be more specifically, the data, whether converted or not, is written into the non-relational database 40 by ways that correspond to the communication modes the relational databases 30 connected thereto. When the communication mode that the relational databases 30 connect to the non-relational database is asynchronous, the data, whether converted or not, is buffered into a memory and subsequently written into the non-relational database 40 on a batch basis when the data in the memory space fulfills a predetermined state. In an embodiment, the predetermined state can be set to one second. In another embodiment, the predetermined state can be a specific capacity of the memory. When the communication mode that the relational databases 30 connect to the non-relational database is synchronous, the data, whether converted or not, will be directly written into the non-relational database 40.

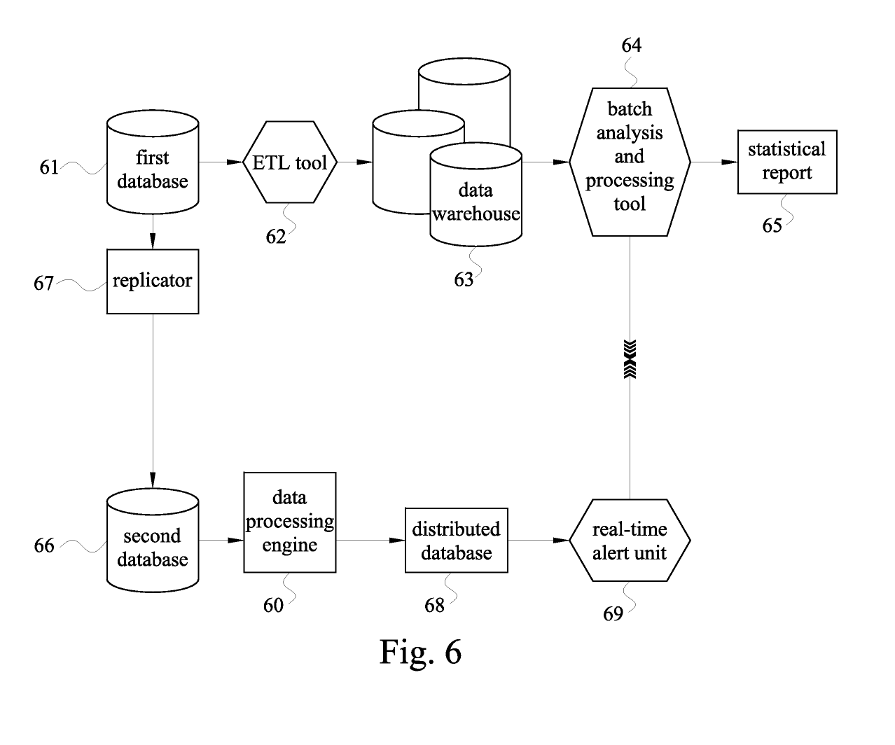

FIG. 6 is a schematic block diagram that shows an architecture of a system provided for real-time processing the continuously-generated data streams in accordance with a preferred embodiment of the disclosure. This figure, together with the data processing engine 20 disclosed in FIGS. 2 and 3, show how to realize the real-time processing. A method of providing the real-time processing of the continuously-generated data streams is as described in FIGS. 4, 5A and 5B. Referring to FIG. 6, the system for real-time processing the data streams comprises a first database 61, a second database 66, a replicator 67, an ETL tool 62, a data warehouse 63, a data processing engine 60 (like the data processing engine 20 shown in FIGS. 2 and 3), and a distributed database 68. The architecture is designed to both preserve the conventional use of the data warehouse and run the real-time processing of the just-mentioned data streams simultaneously. With the architecture, an organization can scale out the system for real-time processing the data streams without jeopardizing the existing operation that uses the data warehouse as an integrated data hub. In an embodiment, the first database 61 is a first collection of relational databases and comprises a plurality of data streams. One skilled in the art should acknowledge that plural descriptions herein are for example and should not be used to limit the scope of the invention. The second database 66, in this case, is a second collection of relational databases. The composition of the second collection is the same as the first collection. Practically, the first collection of the relational databases are for operational purpose and thus mission-critical; the second collection of the relational databases are for analytical purpose. The replicator 67, telecommunicatively coupled to the first database 61 and the second database 66, replicates a copy of the datasets in the first database 61 and transmits the copy to the second database 66. The replicator 67 can real-time replicate incremental data records and transmits them to the second database 66 when data volume grows. In one embodiment, the copy is a replica of full datasets in the first database 61. In another embodiment, the copy is a replica of partial datasets in the first database 61.

The data streams continuously generated by the first database 61 are transmitted to the ETL tool 62 that is telecommunicatively coupled to the first database 61. After being pre-processed by the ETL tool 62, the data streams are transmitted to and stored in the data warehouse 63. The data warehouse 63 is a relational database and the data streams stored therein are further processed by a batch analysis and processing tool 64. Outputs of the further processing are selectively presented in a statistical report 65. The architecture disclosed above is compatible with the conventional infrastructure. However, it cannot provide a real-time processing of the continuously-generated data streams, nor can it provide a real-time alert. To tackle this, the copy transmitted from the second database 66 is converted by the data processing engine 60 in real time and subsequently written into the distributed database 68. The data processing engine 60 is telecommunicatively coupled to the second database 66. The distributed database 68 is a relational database and telecommunicatively coupled to the data processing engine 60.

The system for real-time processing the continuously-generated data streams further comprises a real-time alert unit 69 that is telecommunicatively coupled to the distributed database 68. A trigger is registered on the distributed database 68 to check state differences of certain columns. Take the digital entertainment industry as an example. The state difference can stem from calculations of lifetime value of online games. It is noted that the outputs of the batch analysis and processing tool 64 comprise an upper limit and a lower limit obtained from the further processing. After receiving the state differences from the distributed database 68, the real-time alert unit 69 can compare the state differences to the upper and lower limits, based on which to trigger an alert when the state differences are out of the boundary between the upper and lower limits. Take the semiconductor manufacturing process as an example. When over etching effects occur during the process, the system can actively trigger alerts that notify the personnel to take actions immediately.

The system and method in the present invention are designed to provide the real-time processing of continuously-generated data streams with the disclosed architecture that tackles the drawbacks of the prior art. Practically, architectures of information systems do not come out of nothing, nor do they exist as stand alone. In fact, architectures and technical developments thereof are provided to help industries tackle actual situations under acceptable or affordable conditions, so the significance and necessity of the architectures and relevant technical developments have to be viewed from an overall perspective. The significance and necessity of the present invention lie in the use of the disclosed architecture to achieve the purpose of real-time processing of the data streams without jeopardizing an organization's security policies and performance of its existing operations at the same time. One skilled in the art should acknowledge that the disclosed architecture can be scaled out if necessary and thus the embodiments in the specification are not meant for any limitation of the scope of the present invention.

While the invention is described in detail with reference to illustrated embodiments, it is to be understood that there is no intent to limit the invention to those embodiments. Numerous modifications and variations could be made thereto by those skilled in the art without departing from the scope and spirit of the invention set forth in the claims. For example, any tier or layer of architecture design that is altered by people skilled in the art in order for providing distributed storage, distributed processing and applications/services run on a distributed mode should be included in the scope of the present invention. Any disclosed module, engine, tool, system and database that can be deployed, operate or run on one or more machines, whether in a physical or virtual form, should be also included in the scope of the present invention.

What is claimed is:

1. A method for real-time processing a plurality of continuously-generated data streams transmitted from a relational database and writing outputs derived from the real-time processing to a non-relational database, the method comprising:
identifying categories of the data transmitted from the relational database based on a port that the relational database connects thereto;
setting a communication mode that transmits the data to be synchronous or asynchronous according to the port;
sequentially retrieving each incremental data record based on a primary index;
checking and determining if data schema of the relational database is consistent with that of the non-relational database; if consistent, the data schema of the relational database requires no conversions; otherwise, the data schema of the relational database will be converted into that of the non-relational database; and
writing the data, with the schema being converted or not, into the non-relational database by a way that corresponds to the communication mode.

2. The method for real-time processing a plurality of continuously-generated data streams as claimed in claim 1, wherein, if the communication mode is asynchronous, the data, whether converted or not, is buffered into a memory and subsequently written into the non-relational database on a batch basis when the data in the memory fulfills a predetermined state.

3. A data processing engine for executing the method as claimed in claim 1 receiving a plurality of continuously-generated data streams transmitted from a relational database and writing outputs derived from the real-time processing to a non-relational database, the engine comprising:
a port identification module, for identifying categories of the data transmitted from the relational database based on a port that the relational database connects thereto;
a communication mode setting module, telecommunicatively coupled to the port identification module, for setting a communication mode that transmits the data to be synchronous or asynchronous according to the port;
a receiving module, telecommunicatively coupled to the communication mode setting module, for sequentially retrieving each incremental data record;
a conversion module, telecommunicatively coupled to the receiving module, for checking and determining if data schema of the relational database is consistent with that of the non-relational database; if consistent, the data schema of the relational database requires no conversions; otherwise, the data schema of the relational database will be converted into that of the non-relational database; and
an export module, telecommunicatively coupled to the conversion module, for writing the data, with the schema being converted or not, into the non-relational database by a way that corresponds to the communication mode; wherein, if the communication mode is asynchronous, the data, whether converted or not, is buffered into a memory and subsequently written into the non-relational database on a batch basis when the data in the memory fulfills a predetermined state.

4. A data processing engine for executing the method as claimed in claim 2 receiving a plurality of continuously-generated data streams transmitted from a relational database and writing outputs derived from the real-time processing to a non-relational database, the engine comprising:
a port identification module, for identifying categories of the data transmitted from the relational database based on a port that the relational database connects thereto;
a communication mode setting module, telecommunicatively coupled to the port identification module, for setting a communication mode that transmits the data to be synchronous or asynchronous according to the port;
a receiving module, telecommunicatively coupled to the communication mode setting module, for sequentially retrieving each incremental data record;
a conversion module, telecommunicatively coupled to the receiving module, for checking and determining if data schema of the relational database is consistent with that of the non-relational database; if consistent, the data schema of the relational database requires no conversions; otherwise, the data schema of the relational database will be converted into that of the non-relational database; and
an export module, telecommunicatively coupled to the conversion module, for writing the data, with the schema being converted or not, into the non-relational database by a way that corresponds to the communication mode; wherein, if the communication mode is asynchronous, the data, whether converted or not, is buffered into a memory and subsequently written into the non-relational database on a batch basis when the data in the memory fulfills a predetermined state.

5. A system for real-time processing a plurality of continuously-generated data streams, comprising:
a first database, comprising a first relational database that transmits a plurality of data streams;
a second database, comprising a second relational database;
a replicator, telecommunicatively coupled to the first database and the second database, real-time replicating copies of data records in the first database and transmits the copies to the second database;
an ETL tool, telecommunicatively coupled to the first database, pre-processing the data records transmitted from the first database;
a data warehouse, telecommunicatively coupled to the ETL tool, storing the data records being pre-processed by the ETL tool;
a data processing engine as claimed in claim 3, telecommunicatively coupled to the second database, receiving and processing the copies of data records from the second database; and
a distributed database, telecommunicatively coupled to the data streams processing engine, comprising a non-relational database for storing outputs derived from the processing the copies of the data records by the data processing engine.

6. The system as claimed in claim 5, further comprising a real-time alert unit telecommunicatively coupled to the distributed database for triggering an alert when a state difference in the distributed database is out of a predetermined boundary.

7. The system as claimed in claim 6, wherein the data records stored in the data warehouse are further processed by a batch analysis and processing tool to obtain an upper limit and a lower limit, and the real-time alert unit triggers the alert after comparing the state difference to the upper and lower limits.
